(19) United States
(12) Patent Application Publication
(10) Pub. No.: US 2007/0190367 A1
(43) Pub. Date: Aug. 16, 2007

(54) Manganese Doped Magnetic Semiconductors

(76) Inventors: Venkat Rao, Stockholm (SE); Parmanand Sharma, Delhi (IN); Amita Gupta, Kurukshetra (IN)

Correspondence Address: LADAS & PARRY LLP, 224 SOUTH MICHIGAN AVENUE, SUITE 1600, CHICAGO, IL, 60604, US

(21) Appl. No.: 11/596,342

(22) PCT Filed: May 17, 2005
(86) PCT No.: PCT/SE05/00712

§ 371 Date: Nov. 14, 2006

(30) Foreign Application Priority Data
May 18, 2004 (SE) 0401319-9

(51) Int. Cl. G11B 5/708

(52) U.S. Cl. 428/842.3

(57) ABSTRACT

A semi-conducting material being a non-oxide material or an already doped oxide material, wherein said material is doped with Manganese, Mn, and is ferromagnetic at least at one temperature in the range between room temperature and 500 K. Preferably, the Manganese doped material has a Manganese concentration at or below 5 at %.

### FIELD OF INVENTION

Materials used for electronic components which use ferromagnetism in its function. These types of components are affecting or rectifying the spin orientation of bosons and fennions, e.g. electrons. Search for ferromagnetism above room temperatures in dilute magnetic semiconductors has been a quest in recent years especially to develop potentially rich new class of future devices which exploit the electron spin state i.e. spintronics. The types of components for these devices include e.g. magnetic memories (e.g. hard discs), semiconductor magnetic memories (e.g. MRAM), spin valve transistors, spin light emitting diodes, non-volatile memory, logic devices, quantum computers, optical isolators, sensors and ultra-fast optical switches. Dilute magnetic semiconductors can also be used in electronic-, and magnetic-based products.

### DESCRIPTION OF RELATED ART

Electronic component technologies are increasingly interested in using ferromagnetic materials for new component designs and functions. Traditional ferromagnetic materials are e.g. iron, nickel, cobalt and their alloys. Novel scientific activities and new suggestions for implementing them, are frequently being reported in technical and scientific journals. Some examples of materials expectations with basic component designs can be found in recent review articles in Physics World, (April 1999) and IEEE Spectrum, (December 2001). All these documentations describe the problem and needs in designing ferromagnetic materials that can operate at the industrial, automotive and military temperature range (normally −55° C. to 125° C.).

Most of the materials of interest known today require cryogenic temperatures. However Klaus H. Ploog described in Physical Review Letters, July 2001, the use of a film of iron grown on Gallium Arsenide (GaAs) to polarize the spin of electrons injected into semiconducting GaAs. This experiment was carried out at room temperature.

Spintronic devices such as spin valve transistors, spin light emitting diodes, non-volatile memory, logic devices, optical isolators and ultra-fast optical switches are some of the areas of high interest for introducing the ferromagnetic properties at room temperature in a semiconductor described in the two documents (reference 6-7).

In recent years there have been intense search for materials exhibiting ferromagnetic ordering in doped dilute magnetic semiconductors (DMS), described in the following five documents (reference 1-5), focusing on possible spin transport properties which has many potentially interesting device applications.

Among the materials reported so far, Mn-doped GaAs has been found to be ferromagnetic with the highest reported (se reference 1) Curie temperature, Tc˜110 K. Following this Dietl et al. (see reference 2) predicted on a theoretical basis that ZnO and GaN would exhibit ferromagnetism above room temperature on doping with Mn. This prediction initiated intensive experimental work on a variety of doped dilute magnetic semiconductors. Recently, Tc above room temperature has been reported in Co-doped TiO₂, ZnO, and GaN respectively (se reference 3,8,9). However, in the T₁₋ₓCoₓO sample inhomogeneous clustering of Co was found (see reference 10). Kim et al (see reference 11) showed that while homogeneous films of Zn₁₋ₓCoₓO exhibited a spin-glass behavior, room temperature ferromagnetism was found in inhomogeneous films attributing the observation to the presence of Co clusters. Clearly, for device applications we need homogeneous films. The applicant has already a patent application based on Manganese doping of Zinc Oxide.

### SUMMARY OF INVENTION

The invention is based on the concept to create ferromagnetism into doped dilute magnetic semiconductors by doping with Manganese (Mn) into materials that are non-oxides or into materials that are oxides and already doped by another dopant. These two groups of materials are below called just materials. Tailoring of ferromagnetism above room temperature in bulk or film layers has been achieved. In this state Mn is found to carry a magnetic moment. Ferromagnetic Resonance (FMR) data on these samples confirm the existence of ferromagnetic order at temperatures even as high as 500K. In the paramagnetic state the Paramagnetic Resonance data show that Mn is in the 2+ state. Our ab initio calculations confirm the above findings. On sintering the bulk at above 500K annealing temperatures, the ferromagnetism around room temperatures is completely suppressed giving rise to the often reported pronounced ‘ferromagnetic-like’ ordered state below 40K. The material also shows room temperature ferromagnetic ordering in several μm thick transparent films deposited on different substrates by Pulsed Laser deposition using the same bulk materials as targets. The ferromagnetic dilute Mn doped materials can also be obtained as transparent nanoparticles.

The demonstrated new capability renders possible the realization of complex elements for spintronic devices and other components. Manganese doped materials, with ferromagnetic properties in the specified temperature range, can also be manufactured with a sputtering system where either multi metallic (e.g. Manganese and Copper) targets are used simultaneously or one sintered target consisting of the material and dopants with the proper concentrations.

### BRIEF DESCRIPTION OF DRAWINGS AND DIAGRAMS

FIG. 1 illustrates calculated density of states (DOS) for Mn doped Cd₂₃S₂₄, where Fermi level is set at zero;

FIG. 2 illustrates magnetic hysteretic loops for CdS:Mn 5% at 300 K after subtracting the linear term, where Ms ˜1.61×10-3 emu/g, and the lower diagram showing the loop with the linear term at high fields;

FIG. 3a illustrates CdS:Mn 5% temperature dependence of the magnetization at 1000 Oe; and

FIG. 3b illustrates temperature dependence of inverse susceptibility, 1/χ at 1000 Oe for the material of FIG. 3a.

### DESCRIPTION OF THE PREFERRED EMBODIMENT

This invention is based on the concept to create ferromagnetism in doped dilute magnetic semiconductors by doping with Manganese (Mn) into the materials (that are non-oxides or into materials that are oxides and already doped by another dopant). Examples of the materials that are doped with Manganes are Cadmium Sulfid, Cadmium Selenide, Zinc Sulfide, Zink Selenide, Gallium Phosphide, Copper doped Gallium Nitride, Copper doped Gallium Phosphide, Copper doped Zinc Oxide, Copper doped Gallium Arsenide.

Our experiments show successful tailoring of ferromagnetism above room temperature in bulk Mn doped materials. The Mn doping level should then be less than 6 at % (atomic percent) for bulk materials. Theoretically we find that the upper limit for ferromagnetism is about 5 at % Mn. Experimentally we have found that due to materials problems, above 4 at % Mn there is a clear tendency for the Mn atoms to form clusters which are then antiferromagnetic and that suppresses the ferromagnetic order. SEM observations show, on samples above 2 at %, local clustering and the samples becomes inhomogeneous, which affects the material so that the around room temperatures ferromagnetic effect is nearly suppressed at 4-5 at %.

Ferromagnetic Resonance (FMR) data confirm the existence of ferromagnetic order at temperatures as high as 425K in both pellets and thin films. In the paramagnetic state the EPR spectra show that Mn is in the 2³⁰ state (Mn2⁺). Furthermore, ferromagnetism above room temperature is also observed in the calcined (below 500° C.) powder. Our ab initio calculations confirm the above findings. If sintering of the Mn doped materials is carried out at higher temperatures the doped material shows an additional large paramagnetic contribution at room temperatures and the ferromagnetic component becomes negligible. On sintering the bulk at temperatures above 700° C., ferromagnetism around room temperatures is completely suppressed giving rise to the often reported pronounced ‘ferromagnetic-like’ ordered state below 40K. Experiments with sintering temperatures of 700° C., 800° C. and 900° C. have confirmed this fact.

Room temperature ferromagnetic ordering has also been obtained in 2-3 μm thick films deposited on fused quartz substrates at temperatures below 600° C., by Pulsed Laser deposition or sputtering using the same bulk materials as targets. The doping concentration in these film materials should be less than 6 at % in order to obtain controlled homogeneity. Experiments have shown that samples below 2 at % can be tailored to be homogeneous in composition with slight variations but containing no clusters. In laser ablation the substrate temperature effects the Mn concentration in the film. Films deposited at higher temperatures are found to have a high concentration of Mn in comparison to films deposited at low temperatures. This means that the temperature could be used to control the Mn concentration.

The effect of sintering temperature on the magnetic properties of nominal 2% Mn doped materials was studied. We found ferromagnetic ordering above room temperature (Tc>420K). The room temperature ferromagnetic phase as a function of sintering temperatures, as indicated by M(H) measurements. Elemental mapping for the pellet sintered at 500° C. showed a uniform distribution of Mn in the sample. However local Mn concentration was found to be much lower (˜0.3 at %) than the nominal composition. Taking this fact into consideration, we evaluate the saturation magnetization of the ferromagnetic phase and determine the moment per Mn atom to be 0.16 μB. Sometimes on sintering the pellets in the temperature range 600° C.-700° C. in addition to the ferromagnetic component we observe a linear paramagnetic contribution in the magnetic hysteretic loops at high fields. However, sintering the pellets above 700° C. completely suppresses ferromagnetism around room temperature. The doped dilute semiconductor can also be processed, by particle size selection, into transparent and ferromagnetic nanoparticles.

Manganese doped materials can be manufactured with a sputtering system where either two metallic (material and Manganese) targets are used simultaneously or one sintered ceramic target as described previously. When using two metallic targets the sputtering energy on the material and Manganese targets are adjusted in such a way that the resulting Manganese content is in the 1-6% range. An exact recipe has to be adjusted to the sputtering equipment that is used and depends on energy, geometry and gases. The substrate temperature on the deposition substrate is in the same range as when using laser deposition.

X-ray Diffraction as well as SEM high resolution elemental mapping analyses on both the bulk as well as thin film Mn doped materials obtained by us are found to be homogeneous with no sign of cluster formation or distribution in them.

Incidentally in both the bulk and the transparent films we obtained their ferromagnetic resonance spectra which provide convincing evidence for the existence of ferromagnetism. The demonstrated new capability renders possible the realization of complex elements for spintronic devices. These type of films materials are transparent and could be used for magneto-optical components. These types of materials have a large electromechanical coupling coefficient and is therefore also good for piezoelectric applications and combinations for optical, magneto and mechanical sensor or component solutions.

The table below shows the results of magnetic measurements on CdS:Mn samples. CdS samples doped with Mn, labelled as sample-1 (5%) and sample-2 (4%) were investigated for their magnetic properties. The following measurements were made on each sample:

1. Temperature dependence of magnetization, M(T), at a measuring field of 1000 Oe.

2. Field dependence of magnetization, M (H), at 300K and 5K.

The saturation magnetisation Ms, obtained after subtracting the linear part showing up at higher fields in M (H) curves, and the corresponding coercivity values, Hc are listed in the table given below.

| | Ms at 300K | Ms at 5K | Hc at 300K | |
|---|---|---|---|---|
| Sample | (emu/g) | (emu/g) | (Oe) | Hc at 5K Oe) |
| 1 | ˜1.61 × 10⁻³ | ˜1.59 × 10⁻² | ˜105 | ˜250 |
| 2 | ˜3.07 × 10⁻³ | ˜3.84 × 10⁻² | ˜100 | ˜98 |

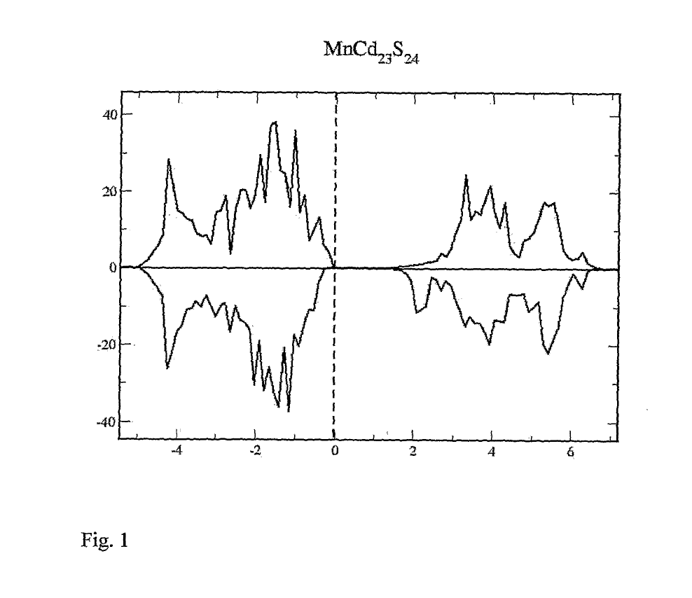

FIG. 1 shows the calculated density of states for Manganese doped Cadmium Sulphide.

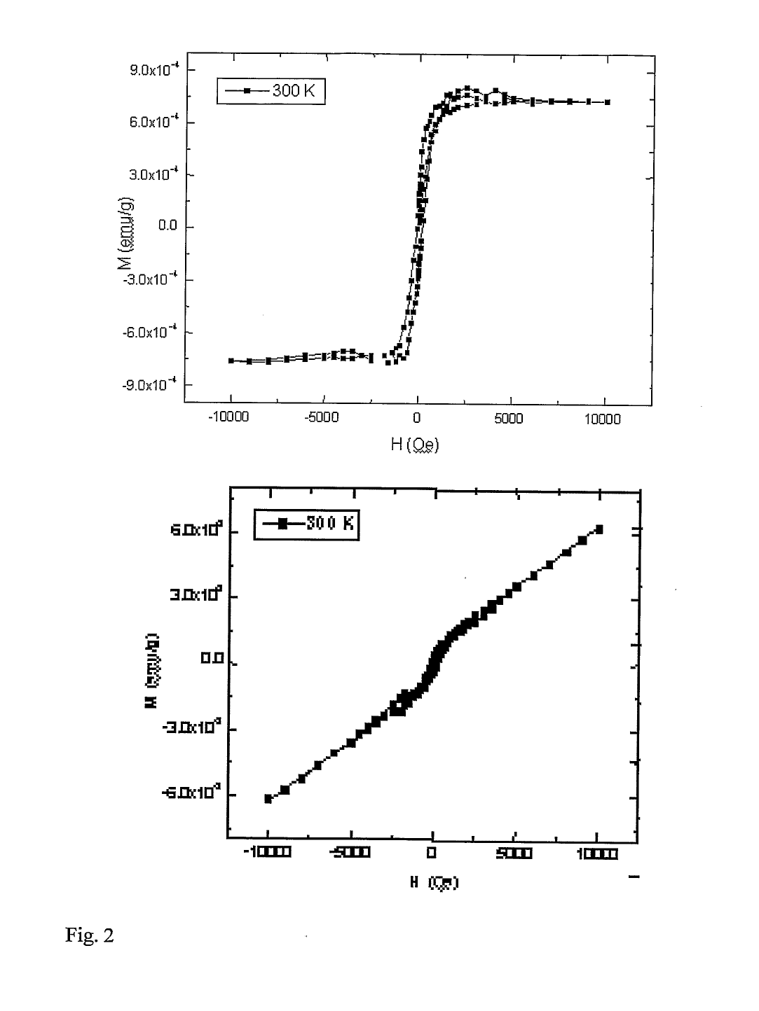

FIG. 2 M (H) at 300 K showing the ferromagnetic phase, at Manganes doped Zinc Sulphide, obtained after subtracting the linear term from the as obtained data. The coercivity is ˜130 Oe and saturation magnetisation is ˜7.45 E-4 emu/g.

The inset shows the as obtained data having a paramagnetic term at high fields.

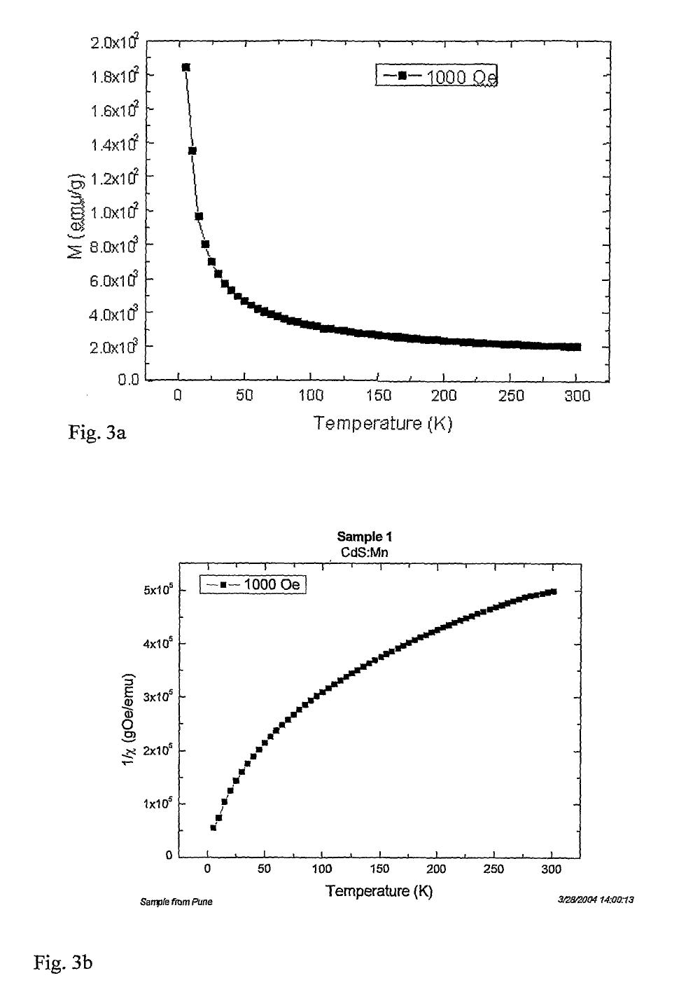

FIG. 3 is showing Cadmium Sulphide doped with 5% Manganese. FIG. 3(a) M(T) at 1000 Oe and FIG. 3(b) 1/χ at 1000 Oe.

### REFERENCES

1. Ohno, H. Making Nonmagnetic semiconductors ferromagnetic.

Science 281, 951-956 (1998); see also a recent review: S. J. Pearton et al JAP 93, 1 (2003).
2. Dietl, T. et al. Zener model description of ferromagnetism in zinc-blende magnetic semiconductors. Science 287, 1019-1022 (2000)
3. Matsumoto, Y. et al. Room-temperature ferromagnetism in transparent transition metal-doped titanium dioxide. Science 291, 854-856 (2001)
4. Ando, K. et al. Magneto-optical properties of ZnO-based dilute magnetic semiconductors. J. Appl. Phys. 89(11), 7284-7286 (2001)
5. Takamura, K. et al. Magnetic properties of (Al,Ga,Mn) As. Appl. Phys. Letts 81(14), 2590-2592 (2002)
6. Chambers, S. A. A potential role in spintronics. Materials Today, 34-39 (April 2002)
7. Ohno, H. Matsukura, F. & Ohno, Y. Semiconductor spin electronics. JSAP international 5, 4-13 (2002)
8. Ueda, K. Tabata, H. & Kawai, T. Magnetic and electric properties of transition-metal-doped ZnO films. Appl. Phys. Letts 79(7), 988-990 (2001)
9. Thaler, G. T. et al. Magnetic properties of n-GaMnN thin films. Appl. Phys. Letts. 80(21), 3964-3966 (2002)
10. Stampe, P. A. et al. Investigation of the cobalt distribution in TiO2:Co thin films. J. Appl. Phys. 92(12), 7114-7121 (2002)
11. Kim, J. H. et al. Magnetic properties of epitaxially grown semiconducting Zn1-xCoxO thin film by pulsed laser deposition. J. Appl. Phys. 92(10), 6066-6071 (2002)
12. Fukumura, T. et al. An oxide-diluted magnetic semiconductor: Mn-doped ZnO. Appl. Phys. Letts. 75(21), 3366-3368 (1999)
13. Fukumura, T. et al. Magnetic properties of Mn doped ZnO. Appl. Phys. Letts. 78(7), 958-960 (2001)
14. Jung, S. W. et al. Ferromagnetic properties of Zn1-xMxO epitaxial thin films. Appl. Phys. Letts. 80(24), 4561-4563 (2002)
15. Tiwari, A. et al. Structural, optical and magnetic properties of diluted magnetic semiconducting Zn1-xMnxO films. Solid State Commun. 121, 371-374 (2002)
16. Total energy calculations were performed using the projector augmented-wave (PAW) method as invoked by the VASP program package based on the generalized-gradient approximation (GGA). The parameterization for the exchange and correlation potential proposed by Perdew et al was employed. In the present calculations we made use of PAW potentials which valence states 3p, 3d and 4s for Mn, 3d and 4s for Zn and 2s and 2p for O. The periodic supercell approach is employed and the energy cutoff was 600 eV. The optimization of the geometry has been done (ionic coordinates and c/a ratio), using the Hellmann-Feynman forces on the atoms and stresses on the supercell for each volume. For sampling the irreducible wedge of the Brillouin zone we used k-point grids of 4×4×2 for the geometry optimization and 8×8×4 for the final calculation at the equilibrium volume.

1-8. (canceled)

9. A semi-conducting material comprising any of the following materials:
Cadmium Sulfid doped with Manganese, Cadmium Selenide doped with Manganese, Zinc Sulfide doped with Manganese, Zinc Selenide doped with Manganese, Gallium Phosphide doped with Manganese, Copper doped Gallium Nitride doped with Manganese, Copper doped Gallium Phosphide doped with Manganese, Copper doped Zinc Oxide doped with Manganese, and Copper doped Gallium Arsenide doped with Manganese,
wherein the Manganese concentration is below 6 at % and the Manganese doped semi-conducting material is ferromagnetic at a temperature exceeding 30° C.

10. A semi-conducting material according to claim 9 wherein the Manganese concentration of said Manganese doped material is below 4 at %.

11. A semi-conducting material according to claim 9 wherein said Manganese doped material is piezoelectric.

12. A semi-conducting material according to claim 9 wherein said Manganese doped material is transparent.

13. A substrate comprising a deposited thin film, said film having a thickness in the order of pm, wherein said film comprises a material according to claim 9.

14. A component to be used for spintronic devices comprising the material according to claim 9.

15. The component according to claim 14 wherein said component is any of the following:
a magnetic memory, a hard disc, a Semi-conductor magnetic memory, a MRAM, a spin valve transistor, a spin light emitting diode, a non-volatile memory, a logic device, an optical isolator, a sensor, and an optical switch.

16. A computer comprising a component according to claim 14.
